(19) United States
(12) Patent Application Publication
(10) Pub. No.: US 2006/0117004 A1
(43) Pub. Date: Jun. 1, 2006

(54) System and method for contextually understanding and analyzing system use and misuse

(76) Inventors: Charles Leighton Hunt, St. Paul, MN (US); Mark Tiggas, Eden Prairie, MN (US); Edward E. Miranda, Waukee, IA (US)

Correspondence Address: GLENN PATENT GROUP, 3475 EDISON WAY, SUITE L, MENLO PARK, CA, 94025, US

(21) Appl. No.: 11/001,197

(22) Filed: Nov. 30, 2004

(51) Int. Cl. G06F 17/30

(52) U.S. Cl. 707/6

(57) ABSTRACT

A system and method for contextually understanding and analyzing system use and misuse are described. In one preferred embodiment, one or more trigger events are detected and information related to the events is received. One or more exception rules are retrieved from exception rules tables within a database and the exception rules are applied to the received information. If a valid exception is identified, an exception notification is created and stored in oversight record tables within the database for further processing. Appropriate recipient users to receive the exception notification are identified from the actions, transactions, and contextual information tables within the database and the exception notification is further transmitted to the identified recipient users.

### TECHNICAL FIELD

The invention relates generally to the field of network-based communications and, more particularly, to a system and method for contextually understanding and analyzing system use and misuse.

### BACKGROUND OF THE INVENTION

With the unprecedented growth of centralized and distributed computerized systems and applications, there is a continuous need to provide integrated views of actions performed by internal and external users of such systems and applications in order to detect, investigate, analyze, and/or prevent fraud and misuse (i.e. behaviors that are or appear to be contrary to an organization's policies).

Several attempts have been made to facilitate such investigations and analyses. For example, some solutions for determining patterns of application and/or system use and misuse have been focused on unauthorized actions and/or attempted unauthorized actions, or patterns of actions (e.g. network traffic), associated with malefic programs (e.g. viruses, Trojan horses, etc.) as evidenced in system network devices (e.g. router, firewall, etc.) and on transaction logs that provide time-phased record of the actions taken on the system and/or application. In some cases, the logs from a number of systems and applications have been merged to provide a more complex view of the actions. While such approaches allow analysts or investigators to determine the sequence of events associated with unauthorized or attempted unauthorized actions, they do not provide an understanding of authorized events that potentially represent fraud or misuse in the context in which they were performed. This is a critical shortcoming because actions may constitute appropriate use in one context but constitute fraud, possible fraud, misuse or possible misuse in a different context.

In addition, system, network, and application logs focus on the actions taken but typically do not address the details of the actions taken, thus overlooking potential evidence of fraud or misuse. Furthermore, the logs and the machines that manipulate them have been focused so far on single automation objectives, such as, for example, intrusion detection or fraud detection, and failed to address the need to conduct and document appropriate management oversight of the actions of approved system users including any automatically identified exception conditions, as well as the need to conduct routine manual reviews of system and/or application usage. These machines have also often failed to provide for the investigation of the details surrounding exceptions or claims of fraud or misuse. This is a critical shortcoming because the details of some actions or transactions carry the evidence of potential fraud or misuse.

### SUMMARY OF THE INVENTION

A system and method for contextually understanding and analyzing system use and misuse are described. In one preferred embodiment, one or more trigger events are detected and information related to the events is received. One or more exception rules are retrieved from exception rules tables within a database and the exception rules are applied to the received information. If a valid exception is identified, an exception notification is created and stored in oversight record tables within the database for further processing. Appropriate recipient users to receive the exception notification are identified from the actions, transactions, and contextual information tables within the database and the exception notification is further transmitted to the identified recipient users.

### BRIEF DESCRIPTION OF THE DRAWINGS

FIG. 1 is a block diagram illustrating an exemplary network-based transaction and communications facility, which includes a system for contextually understanding and analyzing system use and misuse, according to one embodiment of the invention;

FIG. 2 is a block diagram illustrating a system for contextually understanding and analyzing system use and misuse, according to one embodiment of the invention;

FIG. 3 is a flow diagram illustrating a method for contextually understanding and analyzing system use and misuse, according to one embodiment of the invention;

FIG. 4 is a flow diagram illustrating a method for reviewing the analysis of system use and misuse, according to one embodiment of the invention; and

FIG. 5 is a diagrammatic representation of a machine in the exemplary form of a computer system within which a set of instructions may be executed.

### DETAILED DESCRIPTION

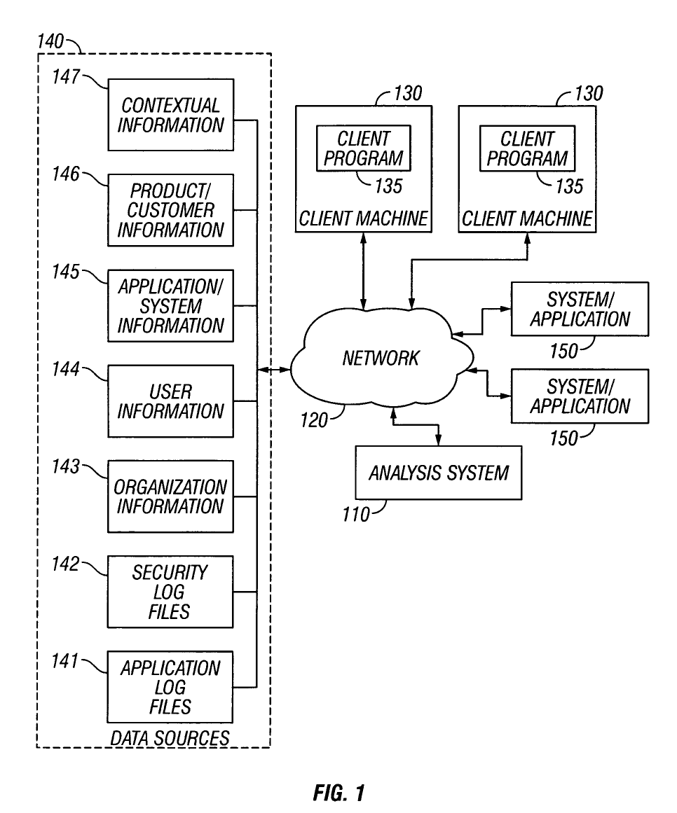

FIG. 1 is a block diagram illustrating an exemplary network-based transaction and communications facility 100, such as, for example, a commercial banking facility, which includes a system for contextually understanding and analyzing system use and misuse. While an exemplary embodiment of the invention is described within the context of a banking facility, it will be appreciated by those skilled in the art that the invention will find application in many different types of computer-based, and network-based, facilities.

As shown in FIG. 1, the block diagram of the facility 100 illustrates the network environment in which the present invention operates. In this conventional network architecture, a system 110 for contextually understanding and analyzing system use and misuse is coupled to a network 120, for example the Internet, and specifically the World Wide Web. Other examples of networks include a wide area network (WAN), a local area network (LAN), a wireless network, e.g. a cellular network, the Plain Old Telephone Service (POTS) network, or other known networks.

Using conventional network protocols, the system 110 may communicate through the network 120 to a plurality of client machines 130, possibly coupled through the network 120 or directly coupled to the system 110. For example, as shown in FIG. 1, client machines 130 are coupled directly to the network 120 through conventional network transmission lines. The system 110 may be accessed by a client program 135, such as a browser (e.g. the Internet Explorer browser distributed by Microsoft Corporation of Redmond, Wash., or the FireFox browser distributed by mozilla.org), a terminal or terminal emulator (e.g. EXTRA! Distributed by Attachmate Corporation of Loveland, Ohio), or other man machine interface (e.g. Convedia CMS-6000 MEDIA SERVER™ Interactive Voice Response (IVR)/Voice Response Unit (VRU) equipment from Convedia Corporation of Vancouver, British Columbia), that executes on a corresponding client machine 130 and accesses the system 110 via the network 120. Using one of a variety of network connection devices, the system 110 can also communicate directly with each client machine 130.

In one embodiment, several system and/or applications 150, such as, for example, banking applications, are coupled to the system 110. Each system/application 150 is further coupled to a data store 155. The applications 150 transmit data sources (e.g. files) 140 to or permit the analysis system 110 to access the data stores (e.g. files, databases, etc.) 155 via the network 120. Alternatively, the applications 150 may be coupled to the system 110 using synchronous and/or asynchronous messages delivered to the system 110 via the network 120, as described in further detail below. In another alternate embodiment, the system 110 may be directly coupled to any of the data stores 155, which store the data sources 140.

In one embodiment, several data sources 140 are transmitted to the system 110 via the network 120. The data sources contain data to be provided to the system 110, such as, for example, application log files 141 containing application log data for one or more applications 150, security log files 142 pertaining to one or more security systems applicable to the facility 100, organization information 143 containing a time series view of working relationships among users of the facility 100, such as bankers, tellers, and other professionals, user information 144 detailing user ID's and access permissions or authority for various systems and applications 150, and other information necessary to support analysis of potential fraud and/or misuse, application/system information 145 such as, for example, reference information about transactions and related data associated with transactions performed within the facility 100, product/customer information 146 such as, for example, data related to customers, products provided to each customer, customer user ID's and access permissions or authority for various systems and applications 150 of the facility 100, reference data related to products supported by the facility 100, and other contextual information 147, such as, for example, information associated with user's or customer's past behavior that could affect the potential fraud and/or misuse investigation and analysis.

In other examples of contextual information 147, if a banker is providing service to customer A and accesses information about customer B (potential exception trigger event), the contextual information refers to the fact that the banker is working with customer A and the out of context behavior is the fact the banker is accessing information about customer B. If a teller on probation is trying to override a withdrawal limit, the contextual information is the teller's employment status (probationary) and the out of context behavior relates to the attempt to override the withdrawal limit. If a back office worker accesses customer information outside of the normal/expected process flow, the contextual information relates to the worker performing a normal flow of transactions for his/her work assignment and the potential exception is the out of flow execution of a transaction. If an assembly line worker is reporting completion of a project on assembly line 1 when assigned to work on assembly line 2, the contextual information relates to the fact that the worker is assigned to work on line 2 and the potential out of context behavior refers to the reporting on assembly line 1. If a banker is changing a customer's phone number when not providing face to face service to that customer, the contextual information relates to the fact that the banker is not providing service to the customer and the potential out of context behavior relates to the change in the customer's phone number.

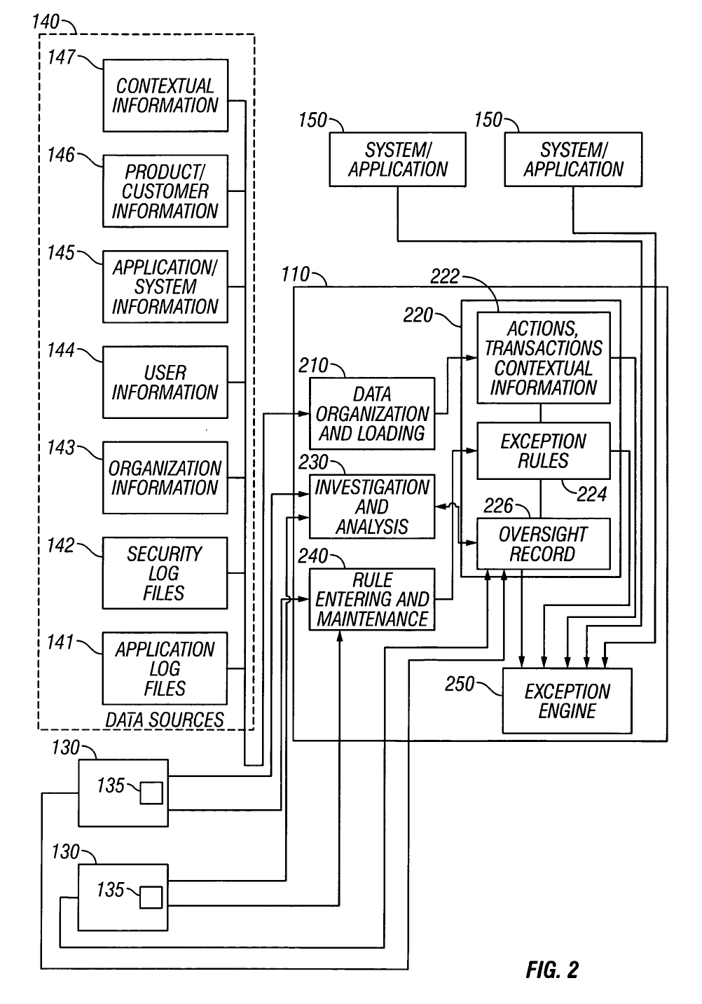

FIG. 2 is a block diagram illustrating a system 110 for contextually understanding and analyzing system use and misuse. As illustrated in FIG. 2, in one embodiment, the system 110 includes a message handling module 205, a data organization and loading module 210 coupled to a database 220, an investigation and analysis module 230 coupled to the database 220, and a rule entering and maintenance module 240 also coupled to the database 220.

The message handling module 205 is a hardware and/or software module configured to communicate with systems and/or applications 150 through synchronous and/or asynchronous messages and communicate to other modules of the analysis system 110, including the data organizing and loading module 210 and the exception engine 250, through means appropriate to the specific implementation of the analysis system 110.

The data organization and loading module 210 is a hardware and/or software module configured to receive the information provided by the data sources 140, such as the application log files 141, the security log files 142, the organization information 143, the user information 144, the application/system information 145, the product/customer information 146, and other contextual information 147, information from the data stores 155, or from the message handling module 205, to organize such information and to store the information in actions, transactions, and contextual information tables 222 within the database 220.

The rule entering and maintenance module 240 is a hardware and/or software module configured to facilitate entering and maintenance of multiple exception rules based on time, events, limits, or patterns of actions performed within the facility 100, as described in further detail below. The rule entering and maintenance module 240 stores the exception rules within exception rules tables 224 within the database 220. In one embodiment of the system 110, module 240 will allow different sets of rules to be maintained for various parts of and/or roles within the organization (e.g. personnel in different roles such as, for example, bankers and tellers in retail banking could have different rules than bankers in commercial banking or underwriters in consumer lending).

The investigation and analysis module 230 is a hardware and/or software module configured to facilitate investigation and analysis of actions performed within the facility 100. In one embodiment, any user of the facility 100 with appropriate access authority may access the module 230 within the system 110 via the client machine 130 and the network 120 and review records stored in the actions, transactions, and contextual information tables 222, the exception rules tables 224, and the oversight record tables 226 of the database 220 in order to carry out actions such as, for example, to conduct research necessary for the disposition of exceptions created by the exception engine 250 and stored in the oversight record tables 226, investigation and disposition of claims of fraud and/or system or application misuse, and to manually create exception records in the oversight record tables 226 needed to record such claims.

The database 220 may, in one embodiment, be implemented as a relational database and includes a number of tables having entries, or records, that are linked by indices and keys, such as, for example, the actions, transactions, and contextual information tables 222, the exception rules tables 224, and oversight record tables 226, which will be described in further detail below. In an alternate embodiment, the database 220 may be implemented as a collection of objects in an object-oriented database.

In one embodiment, the system 110 further includes an exception engine 250 coupled to the database 220. The exception engine 250 is a hardware and/or software module configured to process the exception rules stored in the exception rules tables 224 and to apply the processed rules to actions and transactions within the facility 100. The exception engine 250 creates exception notifications, which are stored in the oversight record tables 226, as described in further detail below. In one embodiment, the exception engine 250 communicates with the message handling module 205 through appropriate methods for the specific implementation of the analysis system 110, whereby such communications prompt the exception engine 250 to perform operations as described herein.

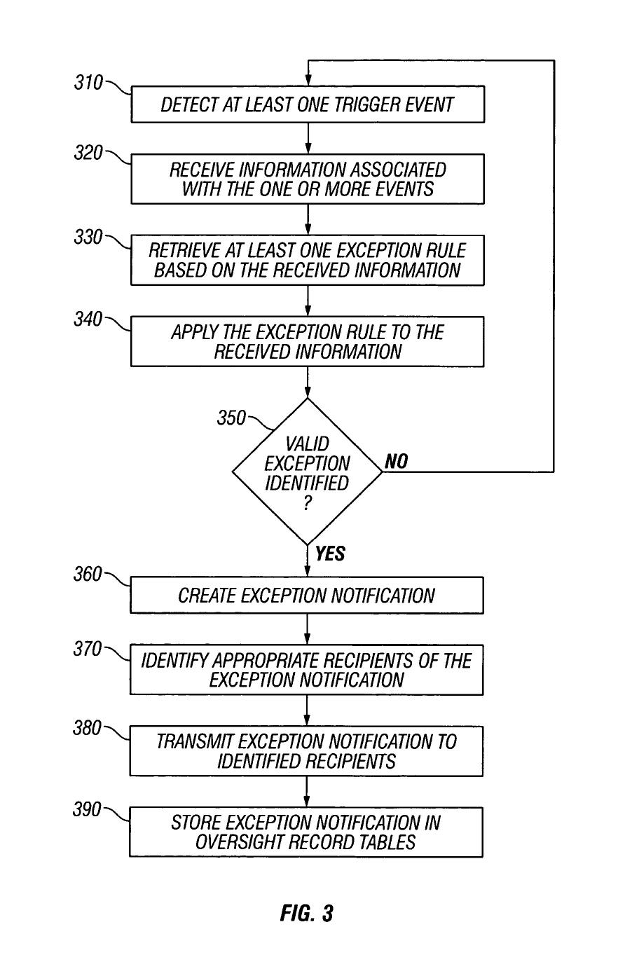

FIG. 3 is a flow diagram illustrating a method for analyzing actions within multiple systems and applications, according to one embodiment of the invention. As illustrated in FIG. 3, at processing block 305, multiple events, such as, for example, potential trigger events, are retrieved from the actions, transactions, and contextual information tables 222 within the database 220 and communications are received from the message handling module 205. In one embodiment, the exception engine 250 retrieves the potential events from the tables 222 within the database 220. The exception engine 250 further receives one or more communications from the message handling module 205 alerting the engine 250 of authorization requests and detailing such authorization requests to be resolved and subsequently approved or denied. The exception engine 250 would determine, for example, if the user should be allowed to perform a certain transaction or action (e.g. to view the customer profile of a customer B while providing service to customer A, or an attempt to override the withdrawal limit while on probationary employment status). The result will be returned to the message handling module 205 for subsequent communication with the system and/or application 150. The potential authorization requests are queued up and routed based on known prioritization rules. In one embodiment, the authorization requests have priority over the retrieved potential trigger events.

At processing block 310, one or more trigger events are detected. In one embodiment, the exception engine 250 detects one or more events within the facility 100, which require further action and analysis. The exception engine 250 may detect a single trigger event, such as, for example, an action by a user of the facility 100 that prompts a comparison with exception rules stored in the database 220. Alternatively, the engine 250 detects a succession of events forming a pattern of behavior, such as, for example, a succession of actions by a user to modify certain parameters within the facility 100 and subsequently to change the parameters to their initial values. In yet another alternate embodiment, the exception engine 250 may detect as a trigger event a communication from the message handling module 205 alerting the engine 250 of an authorization request from an application 150.

At processing block 315, a decision is made whether one or more trigger events are detected. In one embodiment, if no trigger events are detected, then the procedure returns to processing block 305 and processing blocks 305 and 310 are repeated.

Otherwise, if one or more trigger events are detected, at processing block 320, any additional information associated with the detected events is retrieved from the database 220 (e.g. current and historical information). In one embodiment, the exception engine 250 receives details of the detected events or actions, such as user information, details of the transaction or action performed by the user, and/or information about any associated customer or product.

At processing block 330, one or more exception rules are retrieved based on the received information. In one embodiment, the exception engine 250 uses the information associated with the detected event or events to retrieve one or more exception rules from the exception rules tables 224 within the database 220. In one embodiment, authorized users of the facility 100 create exception rules based on time, events (e.g. an employee is transferred), limits (e.g. no more than five customer profiles retrieved that are not associated with an authenticated customer's session), or patterns (e.g. no change of a customer's parameters, such as a customer's phone numbers, back and forth within a predetermined period of time). Each exception rule also includes the criticality of any exceptions to the created rule for various applications 150 within the facility 100 and several notification parameters to be used for creation of exception notifications.

The users access the rule entering and maintenance module 240 within the system 110 via the client program 135 within the client machines 130 and enter the exception rules into the exception rules tables 224 of the database 220. In one embodiment, the users may also access module 240 within the system 110 to modify, maintain, and update the rules stored within the exception rules tables 224.

At processing block 340, the retrieved exception rules are applied to the information associated with the detected event or events. In one embodiment, the exception engine 250 processes the exception rules by applying the one or more exception rules to the trigger events to identify any exceptions requiring further processing.

At processing block 350, a decision is made whether a valid exception is identified. In one embodiment, if the exception engine 250 does not identify any exception to the retrieved rules, then, at processing block 352, a decision is made whether any of the events analyzed are associated with an authorization request received from the application 150 via the message handling module 205. In one embodiment, the exception engine 250 determines whether any of the events were submitted as part of an authorization request.

If none of the events is associated with an authorization request, then the procedure returns to processing block 305 and processing blocks 305 through 340 are repeated. Otherwise, if an event is associated with an authorization request and the authorization request is not an exception, but requires further processing, at processing block 354, the exception engine 250 communicates as needed with the message handling module 205 to allow the authorization request of the application 150 and to transmit an approval response for the authorization request. Subsequently, processing blocks 305 through 340 are repeated.

Referring back to block 350, if the exception engine 250 identifies a valid exception, at processing block 355, a decision is made whether the exception is related to an authorization request. In one embodiment, if the exception engine 250 determines that the exception is related to an authorization request, at processing block 356, a communication is transmitted to the message handling module 205 to disallow the authorization request.

Alternatively, if the valid exception is not associated with an authorization request, at processing block 360, an exception notification is created. In one embodiment, the exception engine 250 creates an exception notification using the notification parameters and information about the criticality to various devices and/or applications 150 within the facility 100.

At processing block 358, if the valid exception is associated with an authorization request, a decision is made whether the attempted action is an exception to the rules. If the attempt that prompted the authorization request is an exception, then processing block 360 is performed and an exception notification is created. Otherwise, if the attempt that prompted the authorization request is not an exception, then the procedure returns to processing block 305 and processing blocks 305 to 357 are repeated.

At processing block 370, the exception notification is stored within the oversight record tables 226. In one embodiment, the exception engine 250 stores the exception notification in the oversight record tables 226 within the database 220 for further processing, such as, for example, further access by the identified recipient users and resolution of the exception, as described in further detail below.

At processing block 380, the appropriate recipient users of the exception notification are identified and the notification is updated. In one embodiment, the exception engine 250 uses the notification parameters within the exception rules and accesses the actions, transactions, and contextual information tables 222 within the database 220 to identify specific recipients of the notification, such as, for example, a user's supervisors, and other entities that require such information, and to update the exception notification in the oversight record tables 226.

Finally, at processing block 390, the exception notification is transmitted to the appropriate recipient users and the notification is updated. In one embodiment, the exception engine 250 transmits the exception notification to the identified recipients via the network 120 and client machines 130. The exception notification may be transmitted, in one embodiment, as an electronic mail message via corresponding electronic mail communication servers (not shown), or, alternatively, as instant messages (IM) via corresponding IM communication servers (not shown), or as any other known type of notification message via corresponding communication servers. The exception engine 250 then updates the exception notification record stored in the oversight record tables 226.

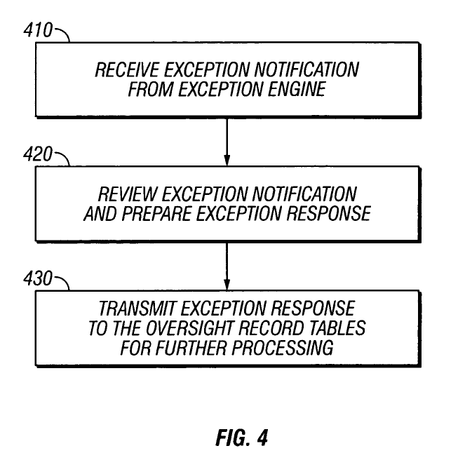

FIG. 4 is a flow diagram illustrating a method for reviewing the analysis of system use and misuse. As illustrated in FIG. 4, at processing block 410, an exception notification is retrieved from the database 220. In one embodiment, a recipient user notified at processing block 390 shown in FIG. 3 retrieves the exception notification from the oversight record tables 226 through the network 120 and the client machine 130.

At processing block 420, the exception notification is reviewed and an exception response is prepared. In one embodiment, the recipient user reviews the notification and takes an action in response to the exception. As a result of the action, the recipient user prepares an exception response documenting the action and/or recommending further processing. The user responding to the exception will utilize the investigation and analysis module 230 to come to an understanding of what happened to cause the exception in order to correctly respond to the exception.

At processing block 430, the exception response is updated in the oversight record tables 226 as part of further processing operations. In one embodiment, the recipient user accesses the system 110 via the client machine 130 and the network 120 and updates the exception response in the oversight record tables 226 within the database 220 for storage and further processing. In one embodiment, the user may close the exception notification stored in the oversight record tables 226 and store a corresponding exception response. Alternatively, the user may add comments to the exception notification that may require further investigation.

Additionally, in one embodiment, at processing block 440, a series of management reports are available to ensure that timely action is being taken and to allow cognizant management to review the types of exceptions being raised and how the exceptions are being disposed of.

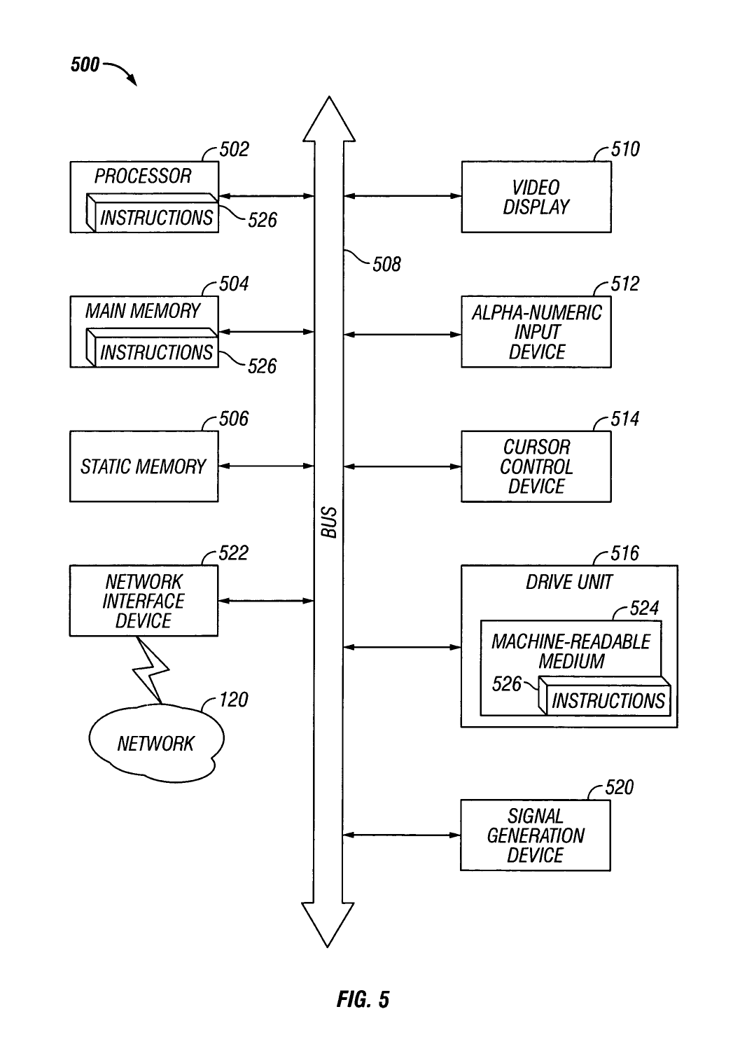

FIG. 5 shows a diagrammatic representation of a machine in the exemplary form of a computer system 500 within which a set of instructions, for causing the machine to perform any one of the methodologies discussed above, may be executed. In alternative embodiments, the machine may comprise a network router, a network switch, a network bridge, Personal Digital Assistant (PDA), a cellular telephone, a web appliance or any machine capable of executing a sequence of instructions that specify actions to be taken by that machine.

The computer system 500 includes a processor 502, a main memory 504 and a static memory 506, which communicate with each other via a bus 508. The computer system 500 may further include a video display unit 510, e.g. a liquid crystal display (LCD) or a cathode ray tube (CRT). The computer system 500 also includes an alphanumeric input device 512, e.g, a keyboard, a cursor control device 514, e.g. a mouse, a disk drive unit 516, a signal generation device 518, e.g. a speaker, and a network interface device 520.

The disk drive unit 516 includes a machine-readable medium 524 on which is stored a set of instructions, i.e. software, 526 embodying any one, or all, of the methodologies described above. The software 526 is also shown to reside, completely or at least partially, within the main memory 504 and/or within the processor 502. The software 526 may further be transmitted or received via the network interface device 520.

It is to be understood that embodiments of this invention may be used as or to support software programs executed upon some form of processing core (such as the CPU of a computer) or otherwise implemented or realized upon or within a machine or computer readable medium. A machine readable medium includes any mechanism for storing or transmitting information in a form readable by a machine, e.g. a computer. For example, a machine readable medium includes read-only memory (ROM); random access memory (RAM); magnetic disk storage media; optical storage media; flash memory devices; electrical, optical, acoustical or other form of propagated signals, e.g. carrier waves, infrared signals, digital signals, etc.; or any other type of media suitable for storing or transmitting information.

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative sense rather than a restrictive sense.

What is claimed is:

1. A method comprising the steps of:
receiving information associated with at least one trigger event within a network-based transaction facility;
retrieving at least one exception rule from a database based on said received information; and
applying said at least one exception rule to said received information to identify an exception to said at least one exception rule.

2. The method according to claim 1, further comprising the step of:
detecting said at least one trigger event from a plurality of events stored in said database.

3. The method according to claim 2, wherein said detecting step further comprises the step of:
detecting said at least one trigger event from at least one action performed by a user within said facility.

4. The method according to claim 2, wherein said detecting step further comprises the step of:
detecting a pattern of behavior of a user within said facility, said pattern containing said at least one trigger event.

5. The method according to claim 2, wherein said detecting step further comprises the step of:
receiving at least one communication from an application within said facility, said at least one communication detailing an authorization request associated with said at least one trigger event.

6. The method according to claim 1, further comprising the steps of:
retrieving a plurality of events from said database, said plurality of events including said at least one trigger event;
receiving at least one communication from an application within said facility, each of said at least one communication detailing an authorization request associated with said at least one trigger event; and
reviewing each event of said plurality of events and each authorization request to detect said at least one trigger event.

7. The method according to claim 6, wherein said each authorization request has priority over said each event of said plurality of events.

8. The method according to claim 1, wherein said information associated with at least one trigger event further comprises detailed information of at least one action performed by a user and associated with said at least one trigger event, information related to said user, and information related to any associated customer of said facility.

9. The method according to claim 1, wherein said at least one exception rule is created by an authorized user of said facility and is stored within exception rules tables in said database.

10. The method according to claim 1, further comprising the step of:
processing said exception according to a plurality of parameters stored within said at least one exception rule.

11. The method according to claim 1, further comprising the steps of:
if no valid exception is identified, determining whether said at least one trigger event is associated with an authorization request from an application within said facility; and
transmitting an approval response for said authorization request to said application, if said at least one trigger event is associated with said authorization request.

12. The method according to claim 10, wherein said processing step further comprises the steps of:
if a valid exception is identified, creating an exception notification based on said plurality of parameters; and
storing said exception notification within oversight record tables in said database for further processing.

13. The method according to claim 12, further comprising the steps of:
identifying at least one recipient user to receive said exception notification; and
transmitting said exception notification to said at least one recipient user for further analysis.

14. The method according to claim 1, wherein said network-based transaction facility is a commercial banking facility.

15. The method according to claim 13, further comprising the step of updating said exception notification in said oversight record tables upon said identifying step and upon said transmitting step.

16. The method according to claim 13, wherein said at least one recipient user further retrieves said exception notification from said oversight record tables and prepares an exception response.

17. The method according to claim 16, wherein said at least one recipient user further transmits said exception response to said oversight record tables and updates said stored exception notification.

18. The method according to claim 10, wherein said processing step further comprises the steps of:
if a valid exception is identified, determining whether said exception is associated with an authorization request from an application within said facility; and
transmitting a response to said application to disallow said authorization request, if said exception is associated with said authorization request.

19. The method according to claim 10, wherein said processing step further comprises the steps of:
if a valid exception is identified, determining whether said exception is associated with an authorization request from an application within said facility;
if said exception is not associated with said authorization request, creating an exception notification based on said plurality of parameters; and
storing said exception notification within oversight record tables in said database for further processing.

20. The method according to claim 19, further comprising the steps of:
if said exception is associated with said authorization request, determining whether an attempted action that prompted said authorization request is an exception to said at least one exception rule; and
if said attempted action is an exception, creating an exception notification based on said plurality of parameters; and
storing said exception notification within oversight record tables in said database for further processing.

21. A system comprising:
means for receiving information associated with at least one trigger event within a network-based transaction facility;
means for retrieving at least one exception rule from a database based on said received information; and
means for applying said at least one exception rule to said received information to identify an exception to said at least one exception rule.

22. The system according to claim 21, further comprising:
means for detecting said at least one trigger event from a plurality of events stored in said database.

23. The system according to claim 22, further comprising:
means for detecting said at least one trigger event from at least one action performed by a user within said facility.

24. The system according to claim 22, further comprising:
means for detecting a pattern of behavior of a user within said facility, said pattern containing said at least one trigger event.

25. The system according to claim 22, further comprising:
means for receiving at least one communication from an application within said facility, said at least one communication detailing an authorization request associated with said at least one trigger event.

26. The system according to claim 21, further comprising:
means for retrieving a plurality of events from said database, said plurality of events including said at least one trigger event;
means for receiving at least one communication from an application within said facility, each of said at least one communication detailing an authorization request associated with said at least one trigger event; and
means for reviewing each event of said plurality of events and each authorization request to detect said at least one trigger event.

27. The system according to claim 26, wherein said each authorization request has priority over said each event of said plurality of events.

28. The system according to claim 21, wherein said information associated with at least one trigger event further comprises detailed information of at least one action performed by a user and associated with said at least one trigger event, information related to said user, and information related to any associated customer of said facility.

29. The system according to claim 21, wherein said at least one exception rule is created by an authorized user of said facility and is stored within exception rules tables in said database.

30. The system according to claim 21, further comprising:
means for processing said exception according to a plurality of parameters stored within said at least one exception rule.

31. The system according to claim 21, further comprising:
if no valid exception is identified, means for determining whether said at least one trigger event is associated with an authorization request from an application within said facility; and
means for transmitting an approval response for said authorization request to said application, if said at least one trigger event is associated with said authorization request.

32. The system according to claim 30, further comprising:
if a valid exception is identified, means for creating an exception notification based on said plurality of parameters; and
means for storing said exception notification within oversight record tables in said database for further processing.

33. The system according to claim 32, further comprising:
means for identifying at least one recipient user to receive said exception notification; and
means for transmitting said exception notification to said at least one recipient user for further analysis.

34. The system according to claim 21, wherein said network-based transaction facility is a commercial banking facility.

35. The system according to claim 33, further comprising means for updating said exception notification in said oversight record tables upon said identifying step and upon said transmitting step.

36. The system according to claim 33, wherein said at least one recipient user further retrieves said exception notification from said oversight record tables and prepares an exception response.

37. The system according to claim 36, wherein said at least one recipient user further transmits said exception response to said oversight record tables and updates said stored exception notification.

38. The system according to claim 30, further comprising:
if a valid exception is identified, means for determining whether said exception is associated with an authorization request from an application within said facility; and
means for transmitting a response to said application to disallow said authorization request, if said exception is associated with said authorization request.

39. The system according to claim 30, further comprising:
if a valid exception is identified, means for determining whether said exception is associated with an authorization request from an application within said facility;
if said exception is not associated with said authorization request, means for creating an exception notification based on said plurality of parameters; and
means for storing said exception notification within oversight record tables in said database for further processing.

40. The system according to claim 39, further comprising:
if said exception is associated with said authorization request, means for determining whether an attempted action that prompted said authorization request is an exception to said at least one exception rule;
if said attempted action is an exception, means for creating an exception notification based on said plurality of parameters; and
means for storing said exception notification within oversight record tables in said database for further processing.

41. A computer readable medium containing executable instructions, which, when executed in a processing system, cause said processing system to perform a method comprising the steps of:
receiving information associated with at least one trigger event within a network-based transaction facility;
retrieving at least one exception rule from a database based on said received information; and
applying said at least one exception rule to said received information to identify an exception to said at least one exception rule.

42. The computer readable medium according to claim 41, wherein said method further comprises the step of:
detecting said at least one trigger event from a plurality of events stored in said database.

43. The computer readable medium according to claim 42, wherein said detecting step further comprises the step of:
detecting said at least one trigger event from at least one action performed by a user within said facility.

44. The computer readable medium according to claim 42, wherein said detecting step further comprises the step of:
detecting a pattern of behavior of a user within said facility, said pattern containing said at least one trigger event.

45. The computer readable medium according to claim 42, wherein said detecting step further comprises the step of:
receiving at least one communication from an application within said facility, said at least one communication detailing an authorization request associated with said at least one trigger event.

46. The computer readable medium according to claim 41, wherein said method further comprises the steps of:
retrieving a plurality of events from said database, said plurality of events including said at least one trigger event;
receiving at least one communication from an application within said facility, each of said at least one communication detailing an authorization request associated with said at least one trigger event; and
reviewing each event of said plurality of events and each authorization request to detect said at least one trigger event.

47. The computer readable medium according to claim 46, wherein said each authorization request has priority over said each event of said plurality of events.

48. The computer readable medium according to claim 41, wherein said information associated with at least one trigger event further comprises detailed information of at least one action performed by a user and associated with said at least one trigger event, information related to said user, and information related to any associated customer of said facility.

49. The computer readable medium according to claim 41, wherein said at least one exception rule is created by an authorized user of said facility and is stored within exception rules tables in said database.

50. The computer readable medium according to claim 41, wherein said method further comprises the step of:
processing said exception according to a plurality of parameters stored within said at least one exception rule.

51. The computer readable medium according to claim 41, wherein said method further comprises the steps of:
if no valid exception is identified, determining whether said at least one trigger event is associated with an authorization request from an application within said facility; and
transmitting an approval response for said authorization request to said application, if said at least one trigger event is associated with said authorization request.

52. The computer readable medium according to claim 50, wherein said processing step further comprises the steps of:
if a valid exception is identified, creating an exception notification based on said plurality of parameters; and
storing said exception notification within oversight record tables in said database for further processing.

53. The computer readable medium according to claim 52, wherein said method further comprises the steps of:
identifying at least one recipient user to receive said exception notification; and
transmitting said exception notification to said at least one recipient user for further analysis.

54. The computer readable medium according to claim 41, wherein said network-based transaction facility is a commercial banking facility.

55. The computer readable medium according to claim 53, wherein said method further comprises the step of updating said exception notification in said oversight record tables upon said identifying step and upon said transmitting step.

56. The computer readable medium according to claim 53, wherein said at least one recipient user further retrieves said exception notification from said oversight record tables and prepares an exception response.

57. The computer readable medium according to claim 56, wherein said at least one recipient user further transmits said exception response to said oversight record tables and updates said stored exception notification.

58. The computer readable medium according to claim 50, wherein said processing step further comprises the steps of:
if a valid exception is identified, determining whether said exception is associated with an authorization request from an application within said facility; and
transmitting a response to said application to disallow said authorization request, if said exception is associated with said authorization request.

59. The computer readable medium according to claim 50, wherein said processing step further comprises the steps of:
if a valid exception is identified, determining whether said exception is associated with an authorization request from an application within said facility;
if said exception is not associated with said authorization request, creating an exception notification based on said plurality of parameters; and
storing said exception notification within oversight record tables in said database for further processing.

60. The computer readable medium according to claim 59, wherein said method further comprises the steps of:
if said exception is associated with said authorization request, determining whether an attempted action that prompted said authorization request is an exception to said at least one exception rule; and
if said attempted action is an exception, creating an exception notification based on said plurality of parameters; and
storing said exception notification within oversight record tables in said database for further processing.

61. A system comprising:
a database; and
an exception engine coupled to said database for receiving information associated with at least one trigger event within a network-based transaction facility, for retrieving at least one exception rule from said database based on said received information, and for applying said at least one exception rule to said received information to identify an exception to said at least one exception rule.

62. The system according to claim 61, wherein said exception engine further detects said at least one trigger event from a plurality of events stored in said database.

63. The system according to claim 62, wherein said exception engine further detects said at least one trigger event from at least one action performed by a user within said facility.

64. The system according to claim 62, wherein said exception engine further detects a pattern of behavior of a user within said facility, said pattern containing said at least one trigger event.

65. The system according to claim 62, further comprising:
a message handling module coupled to said exception engine, wherein said exception engine further receives at least one communication from an application within said facility via said message handling module, said at least one communication detailing an authorization request associated with said at least one trigger event.

66. The system according to claim 61, wherein said exception engine further retrieves a plurality of events from said database, said plurality of events including said at least one trigger event, receives at least one communication from an application within said facility, each of said at least one communication detailing an authorization request associated with said at least one trigger event, and reviews each event of said plurality of events and each authorization request to detect said at least one trigger event.

67. The system according to claim 66, wherein said each authorization request has priority over said each event of said plurality of events.

68. The system according to claim 61, wherein said information associated with at least one trigger event further comprises detailed information of at least one action performed by a user and associated with said at least one trigger event, information related to said user, and information related to any associated customer of said facility.

69. The system according to claim 61, wherein said at least one exception rule is created by an authorized user of said facility and is stored within exception rules tables in said database.

70. The system according to claim 61, wherein said exception engine further processes said exception according to a plurality of parameters stored within said at least one exception rule.

71. The system according to claim 61, further comprising:
a message handling module coupled to said exception engine;
wherein, if no valid exception is identified, said exception engine further determines whether said at least one trigger event is associated with an authorization request from an application within said facility, and transmits an approval response for said authorization request to said application via said message handling module, if said at least one trigger event is associated with said authorization request.

72. The system according to claim 70, wherein, if a valid exception is identified, said exception engine further creates an exception notification based on said plurality of parameters, and stores said exception notification within oversight record tables in said database for further processing.

73. The system according to claim 72, wherein said exception engine further identifies at least one recipient user to receive said exception notification, and transmits said exception notification to said at least one recipient user for further analysis.

74. The system according to claim 71, wherein said network-based transaction facility is a commercial banking facility.

75. The system according to claim 73, wherein said exception engine further updates said exception notification in said oversight record tables upon said identifying step and upon said transmitting step.

76. The system according to claim 73, wherein said at least one recipient user further retrieves said exception notification from said oversight record tables and prepares an exception response.

77. The system according to claim 76, wherein said at least one recipient user further transmits said exception response to said oversight record tables and updates said stored exception notification.

78. The system according to claim 70, further comprising:
a message handling module coupled to said exception engine;
wherein, if a valid exception is identified, said exception engine further determines whether said exception is associated with an authorization request from an application within said facility, and transmits a response to said application to disallow said authorization request via said message handling module, if said exception is associated with said authorization request.

79. The system according to claim 70, wherein, if a valid exception is identified, said exception engine further determines whether said exception is associated with an authorization request from an application within said facility, and, wherein, if said exception is not associated with said authorization request, said exception engine further creates an exception notification based on said plurality of parameters and stores said exception notification within oversight record tables in said database for further processing.

80. The system according to claim 79, wherein, if said exception is associated with said authorization request, said exception engine further determines whether an attempted action that prompted said authorization request is an exception to said at least one exception rule, and, if said attempted action is an exception, further creates an exception notification based on said plurality of parameters and stores said exception notification within oversight record tables in said database for further processing.
